(19) United States
(12) Patent Application Publication
(10) Pub. No.: US 2011/0120298 A1
(43) Pub. Date: May 26, 2011

(54) SLAVE CYLINDER

(75) Inventor: Markus Heitbaum, Buehlertal (DE)

(73) Assignee: SCHAEFFLER TECHNOLOGIES GMBH & CO. KG, Herzogenaurach (DE)

(21) Appl. No.: 13/055,184

(22) PCT Filed: Jun. 29, 2009
(86) PCT No.: PCT/DE09/00896

§ 371 Date: Jan. 21, 2011

(30) Foreign Application Priority Data
Jul. 21, 2008 (DE) 10 2008 033 699.8

(51) Int. Cl. F15B 11/08

(52) U.S. Cl. 92/165 R

(57) ABSTRACT

A slave cylinder inside a hydraulic section for clutch actuation. The slave cylinder is arranged concentrically about a transmission input shaft in the region of two different diameters that come in direct contact with each other. In order to create a slave cylinder with a compact design, despite unfavorable space conditions, the ratio of 2:1 between the mean housing diameter and the necessary guide length can be implemented, both the inner surface of the housing directed toward the transmission input shaft and the piston are congruent in the longitudinal section with the outer shape of the stepped transmission input shaft such that the piston is guided in the housing at the inside diameter on the clutch-side end and at the outside diameter on the transmission-side end.

The invention relates to a slave cylinder within a hydraulic section for clutch actuation, which slave cylinder is arranged concentrically around a transmission input shaft and has the features of the preamble of claim 1.

A slave cylinder of this type is known, for example, from DE 10 2007 023 A1. In this case an annular piston guided on the inner lateral surface in the housing and subjected to pressure is displaced axially in order to move a bearing race of a disengaging bearing fastened to the end face of said annular piston in the direction either towards or away from the clutch. An objective of this solution is to increase service life by lubrication of the running or guide surfaces. In order to achieve guidance of the piston during its disengagement travel when there is a high proportion of load on the guide surface, the guide length of the annular piston is dimensioned according to the internal diameter of the housing, which forms the guide diameter. It is usual in practice to respect a ratio of 2:1 between the mean housing diameter and the required guide length.

However, in some vehicles, such as hybrid vehicles, in which the transmission input shaft does not have a continuously equal diameter, the space available for installing a slave cylinder is very restricted, so that said slave cylinder must have a compact structure corresponding to the straight region of the transmission input shaft. FR 2 697 879 A1 discloses a slave cylinder which solves this problem in that the piston is formed by two pistons which can be nested concentrically one inside the other, so that the guide length can be lengthened axially in a telescopic manner. To make possible the telescopic retraction and to reduce static friction, a channel with fluid is provided between the sliding surfaces of the two pistons over their length. However, if the fluid film between the sliding surfaces ruptures, this leads to an increase in friction, thereby producing undesired operating noise which leads to a reduction of the service life of the slave cylinder and also to a decrease in driving comfort.

It is therefore the object of the invention to develop a slave cylinder which has a compact structure on account of restricted space conditions and in which the ratio of 2:1 between the mean housing diameter and the required guide length is achieved without the introduction of additional channels for lubricants.

This object is achieved with a slave cylinder having the features of claim 1.

To achieve this object use is made of a slave cylinder with a hollow-cylindrical housing having an axial extent, which housing is open on the clutch side and is delimited at its end on the transmission side by an extension disposed in the radial direction. Axially displaceable within the cylindrical interior of this housing is an annular piston which, like the housing, is arranged concentrically around a transmission input shaft having an axis of rotation. Because the transmission input shaft has in the region of the receptacle of the slave cylinder two different diameters which are directly contiguous to one another, both the inner surface of the housing oriented towards the transmission input shaft and the piston are configured to be congruent in longitudinal section with the external shape of the transmission input shaft, the piston being guided, in the housing, on its internal diameter at its end on the clutch side and on its external diameter at its end on the transmission side.

In this way it is ensured that the guide length meets the requirements and that tilting of the piston over its disengagement travel is avoided, whereby the service life of the slave cylinder can be lengthened.

Advantageous configurations of the invention are apparent from the dependent claims.

The invention is explained in more detail below with reference to an exemplary embodiment and to the associated drawing, in which:

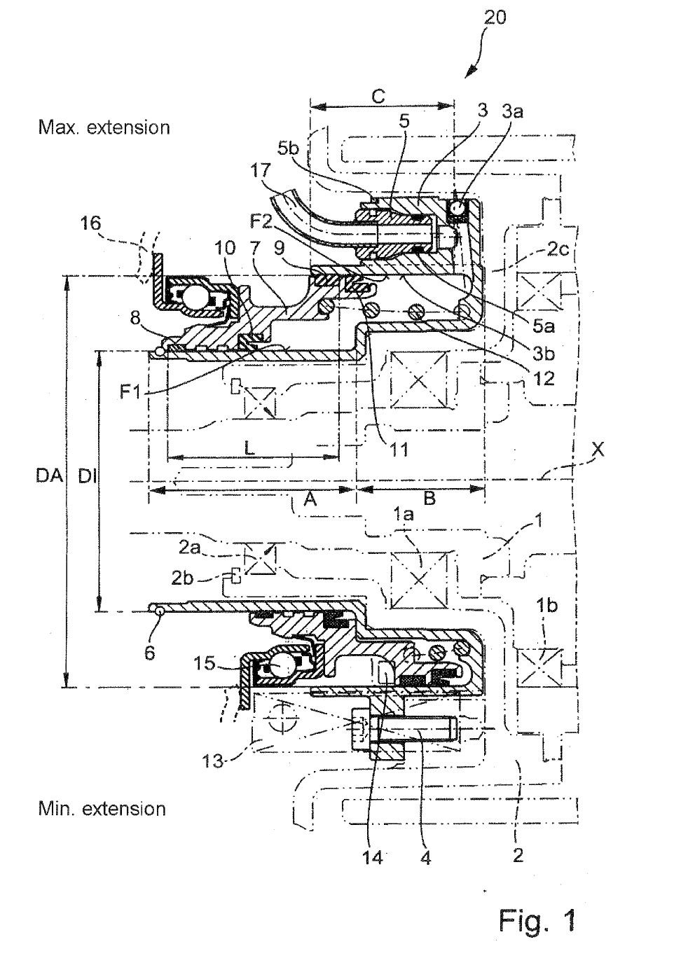

FIG. 1 shows a partial section through a slave cylinder arranged concentrically around a transmission input shaft.

In FIG. 1 the axis of rotation X, which coincides with the axis of rotation of a slave cylinder 20, is used at the same time to represent said slave cylinder 20 in two states of disengagement. Thus, the slave cylinder 20 is shown in its maximum disengagement position above the axis of rotation X and in its minimum disengagement position below the axis of rotation X. This slave cylinder 20 is arranged concentrically around an indicated transmission input shaft 1 in the form of a hollow shaft which, in the region of the receptacle of the slave cylinder 20, has two directly contiguous different diameters, so that a step is formed by the sudden jump from one diameter to the other. Arranged at a distance from one another on this transmission input shaft 1 are a rolling bearing 1a and a radial shaft sealing ring 2a, the outer race of the rolling bearing 1a and the lateral surface of the housing of the radial shaft sealing ring 2a being supported on a bearing flange 2 which is connected to a clutch bell (not shown). The inner race of the rolling bearing 2a is fixed in position by means of a snap ring 2b which engages in the end region of the bearing flange 2 on the clutch side. The shape of the bearing flange 2 is adapted to that of the stepped transmission input shaft 1. In addition, the bearing flange 2 has in the radial direction an extension 2c. A further rolling bearing 1b is provided on the transmission-side end face of this radial extension 2c in order to mount or support the transmission input shaft 1. Fitted into the pot-shaped bearing flange 2, which is supported on the rolling bearings 1a and 2a, is the housing 3, adapted to the internal shape of said bearing flange 2, of a slave cylinder (CSC) arranged concentrically around the transmission input shaft 1. The axial extent of the internal surface of the housing 3 oriented towards the transmission input shaft 1 is adapted to the stepped shape of the transmission input shaft 1, so that, as a result of the step, it is divided into two axial regions A and B.

In this figure the end of a conduit 17 can be seen, from which it is apparent that the CSC has a hydraulic connection. This conduit 17 is introduced into the housing 3 by means of a plug-in connector 5. In this case the plug-in connector 5 is fixed and also sealed in the receiving bore of the housing 3 by means of an O-ring 5a and a securing element in the form of a wire spring clip 5b. The bore of the inlet, necessary for manufacturing reasons, is closed with the aid of a sealing plug 3a. The housing 3 of the CSC is subdivided radially, parallel to the axis of rotation X of the transmission input shaft 1, by a wall 3b into two functional regions. The first, inner region, which is thus pot-shaped in cross section, serves to receive a piston 7 which is axially movable therein, while the outer functional region serves to fasten the housing 3 to the bearing flange, as is apparent from a fastening screw 4 in the sectional representation below the axis of rotation X. The pot-shaped region therefore has an inner diameter DI and an outer diameter DA. The space formed between these two diameters DA and DI delimits a pressure chamber in the radial direction. In the axial direction this pressure chamber is delimited by the piston 7 and by the inner face of the extension 2c on the clutch side. The drawn-in wall 3b in the housing forms over its axial length a region C, the inner surface of which serves as a guide surface, so that the annular piston 7, which is subjected to pressure by means of an energy accumulator in the form of a preloading spring, is guided with both its internal and its external diameter and therefore is guided on a guide surface in region A and at the same time in region C of the housing. Tilting of the piston 7 during its axial movement is thereby avoided. Region B of the housing 3 serves to receive the energy accumulator 12, the end windings of which bear respectively against the piston 7 and the extension 2c. In order to seal the pressure chamber, the piston 7 has on its internal circumference a sealing element 10 in the form of an inner groove seal, and on its outer circumference a sealing element 11 in the form of an outer groove seal. Connected to the piston 7 on the clutch side is a disengaging bearing 15, the inner race of which is operatively connected to a disk spring 16 (only indicated in the FIGURE). In order to improve the sliding movement, both the internal diameter and the external diameter of the piston 7 are provided with guide bands 8 and 9, via which the piston 7 is in direct contact with the surrounding guide surfaces. The difference of the distance between the two guide bands 8 and 9 yields the guide length L of the piston 7. For adaptation to the stepped transmission input shaft 1 and the stepped bearing flange 2, the annular piston 7 also has a stepped configuration in longitudinal section. It is thereby made possible that the axial distance between the respective outer edges of the guide bands 8 and 9 is increased, and that the piston 7 is therefore guided over the whole guide length L during the disengagement process. Through this design measure whereby the piston 7 is guided, in the housing 3, on its internal diameter at its end on the clutch side and on its external diameter at its end on the transmission side, it is therefore possible to achieve the ratio of 2:1 yielded by the required guide length in relation to the mean guide diameter, the mean guide diameter being formed from the mean value of the sum of the diameters DA and DI. In order to sense the disengagement travel of the piston 7, said piston 7 is provided with an information transmitter in the form of a magnet 14 which is in transmission contact with an information receiver in the form of a sensor 13 mounted on the housing 3.

### LIST OF REFERENCES

1 Stepped transmission input shaft
1a Rolling bearing
1b Rolling bearing
2 Bearing flange (screw-fixed in clutch bell)
2a Radial shaft sealing ring
2b Snap ring
2c Extension
3 CSC housing
3b Wall
3a Non-removable sealing plug
4 Fastening screw
5 Plug-in connector
5a O-ring
5b Securing element
6 Snap ring
7 Piston
8 Inner guide band
9 Outer guide band
10 Sealing element
11 Sealing element
12 Energy accumulator
13 Sensor
14 Magnet
15 Disengaging bearing
16 Disk spring tongues of a conventional clutch
17 Conduit
20 Slave cylinder
A Region
B Region
C Region
DI Internal diameter of the piston
DA External diameter of the piston
F1 Guide surface
F2 Guide surface
X Axis of rotation
L Guide length

1. A slave cylinder, comprising:
a hollow-cylindrical housing having an axial extent, which housing is open on a clutch side and is delimited at an end on a transmission side by an extension disposed in a radial direction; and
an annular piston which is axially displaceable in a cylindrical interior and is arranged concentrically around a transmission input shaft having an axis of rotation,
wherein the transmission input shaft has, in a region of a receptacle of the slave cylinder, two directly contiguous different diameters, and both the inner surface of the housing oriented towards the transmission input shaft and the piston are configured to be congruent with an external shape of the transmission input shaft in longitudinal section, the piston being guided, in the housing, on an internal diameter at its end on the clutch side and on an external diameter at the end on the transmission side.

2. The slave cylinder as claimed in claim 1, wherein the different diameters of the transmission input shaft form a step in the region of the receptacle of the slave cylinder.

3. The slave cylinder as claimed in claim 1, wherein the housing has a wall disposed coaxially with the axis of rotation, which wall subdivides said housing into a radially inner pot-shaped functional region and a radially outer fastening region.

4. The slave cylinder as claimed in claim 3, wherein the pot-shaped functional region of the housing is composed in an axial direction of regions and which form a step, and of a region located opposite the regions which form the step.

5. The slave cylinder as claimed in claim 3, wherein the inner surfaces of the housing oriented towards one another are each implemented as respective guide surfaces in one of the regions which form the step and the region located opposite the regions which form the step.

6. The slave cylinder as claimed in claim 4, wherein the housing has an inner diameter in one of the regions which form the step.

7. The slave cylinder as claimed in claim 6, wherein inner diameter of the wall of the housing has an outer diameter in the region which is located opposite the regions which form the step.

8. The slave cylinder as claimed in claim 7, wherein the outer diameter and the inner diameter each form the boundaries in the radial direction for a pressure chamber which is provided therebetween.

9. The slave cylinder as claimed in claim 8, wherein a width of the piston is adapted to a distance between the inner diameter and the outer diameter.

10. The slave cylinder as claimed in claim 1, wherein the piston adopts substantially a shape of a step over a width in longitudinal section.

11. The slave cylinder as claimed in claim 10, wherein a height of the step in the longitudinal section of the piston is adapted to the height of the step from one region to another region in the housing.

12. The slave cylinder as claimed in claim 1, wherein an internal surface at the end of the piston on the clutch side has at least one sealing element and a guide band.

13. The slave cylinder as claimed in claim 12, wherein the piston is guided by means of the guide band along a region of a guide surface of the housing.

14. The slave cylinder as claimed in claim 1, wherein a cylindrical surface at the end of the piston on the transmission side has at least one sealing element and a guide band.

15. The slave cylinder as claimed in claim 12, wherein the piston is guided by means of the guide band along a region of a guide surface of the housing.

16. The slave cylinder as claimed in claim 12, wherein a guide length of the piston is yielded by a distance between a outer edge of the guide band on the clutch side and a outer edge of the guide band on the transmission side.

17. The slave cylinder as claimed in claim 14, wherein a guide length of the piston is yielded by a distance between a outer edge of the guide band on the clutch side and a outer edge of the guide band on the transmission side.
